(19) United States
(12) Patent Application Publication
(10) Pub. No.: US 2025/0172087 A1
(43) Pub. Date: May 29, 2025

(54) RESERVOIR TANK

(71) Applicant: Hanon Systems, Daejeon (KR)

(72) Inventors: Jung Sam Gu, Daejeon (KR); Seong Woo Jeong, Daejeon (KR); Jungbum Choi, Daejeon (KR)

(21) Appl. No.: 18/851,119

(22) PCT Filed: Aug. 10, 2023
(86) PCT No.: PCT/KR2023/095046

§ 371 Date: Sep. 26, 2024

(30) Foreign Application Priority Data
Oct. 19, 2022 (KR) 10-2022-0134910

(51) Int. Cl. F01P 11/02; F01P 11/04

(52) U.S. Cl. CPC F01P 11/029; F01P 11/04; F01P 2050/22

(57) ABSTRACT

Reservoir tank including a main body having a coolant injection part storing a coolant, an inlet pipe connected to one side of the main body and communicating with the inside of the main body, and an outlet pipe connected to the other side of the main body and communicating with the inside of the main body, in which a height of an upper end of one side of the main body is lower than a height of an upper end of the other side of the main body, and the inlet pipe is connected to the main body for the coolant to flow from the upper end of one side of the main body towards a lower end, preventing occurrence of bubbles in the coolant by suppressing a wave effect on the surface of the coolant in the reservoir tank by flow of the coolant into the reservoir tank.

### TECHNICAL FIELD

The present invention relates to a reservoir tank connected to a line through which a coolant for a vehicle circulates, the reservoir tank being configured to store the coolant and supplement the coolant.

### BACKGROUND ART

Recently, in the field of vehicles, electric vehicles have been in the limelight as solutions for implementing environmentally-friendly technologies and solving problems such as energy depletion.

Because the electric vehicle travels by using a motor that operates by receiving electric power from a battery or a fuel cell, the electric vehicle emits a small amount of carbon and causes low noise. In addition, because the electric vehicle uses a motor excellent in energy efficiency in comparison with an engine in the related art, the electric vehicle is environmentally-friendly.

The electric vehicle is equipped with a thermal management system that cools and heats the interior to condition the air in the interior and cools and heats electrical components such as a drive motor, a battery, and an inverter. The thermal management system includes a coolant system configured to heat the interior of the vehicle and cool and heat the electrical components.

A reservoir tank may be connected to a coolant line through which a coolant of the coolant system circulates. The reservoir tank may store the coolant, and the reservoir tank may supplement the coolant to the coolant line in which the coolant is insufficient.

Unlike the reservoir tank simply connected to the coolant line through a branch line and configured to mainly serve to supplement the coolant to the coolant line in which the coolant is insufficient, there is a reservoir tank connected in series to the coolant line and configured to allow the coolant to flow in the reservoir tank. As illustrated in FIG. 1, a reservoir tank, which is configured to allow a coolant to flow therein as described above, has a coolant injection port 1 so that the coolant may be injected into a tank main body 10. A coolant inlet port 2, through which the coolant flowing along the coolant line is introduced, is formed, and a coolant discharge port 3, through which the coolant is discharged, is formed. The coolant inlet port and the coolant discharge port are connected in series to the coolant line, such that the coolant flowing through the coolant line may pass through the reservoir tank.

However, bubbles are frequently generated in the reservoir tank by a flow of the coolant, and the bubbles are introduced into a coolant pump and erode the inside of the coolant pump, which degrades durability. In this case, the main cause of the occurrence of bubbles is a wave effect in which bubbles are generated as the coolant sloshes over a surface of the coolant and traps air by the coolant with a high flow velocity introduced into the reservoir tank.

In order to prevent the occurrence of bubbles, as illustrated in FIG. 2, in the reservoir tank in the related art, a part of the coolant inlet port 2 is inserted into the tank main body 10, and the coolant inlet port 2 is formed to be directed downward. However, even this configuration causes the occurrence of bubbles because of the wave effect over the surface of the coolant caused in accordance with the flow velocity of the coolant.

### DOCUMENT OF RELATED ART

### Patent Document

KR 2021-0096343 A (Aug. 5, 2021)

### DISCLOSURE

### Technical Problem

The present invention has been made in an effort to solve the above-mentioned problem, and an object of the present invention is to provide a reservoir tank having an inlet port, through which a coolant is introduced, and a discharge port, through which the coolant is discharged, the reservoir tank being capable of preventing the occurrence of bubbles in the coolant by suppressing a wave effect generated on a surface of the coolant in the reservoir tank by a flow of the coolant introduced into the reservoir tank.

### Technical Solution

In order to achieve the above-mentioned object, a reservoir tank of the present invention includes: a tank main body having a coolant injection part and configured to store a coolant therein; an inlet pipe connected to one side of the tank main body and configured to communicate with the inside of the tank main body; and an outlet pipe connected to the other side of the tank main body and configured to communicate with the inside of the tank main body, in which a height of an upper end of one side of the tank main body is lower than a height of an upper end of the other side of the tank main body, and the inlet pipe is connected to the tank main body so that the coolant flows in a direction toward a lower end from the upper end of one side of the tank main body.

In addition, the reservoir tank may have a stepped portion formed at one side thereof so that a height of an upper end of one side is lower than a height of an upper end of the other side.

In addition, the inlet pipe may be connected to an upper surface of the stepped portion.

In addition, at least a part of the inlet pipe may be inserted into one side of the tank main body, and a lower end of the inlet pipe disposed in one side of the tank main body may be disposed to be adjacent to and spaced apart from the lower end of one side of the tank main body.

In addition, the inlet pipe may include: a first pipe portion extending in an upward/downward direction and partially inserted into one side of the tank main body; and a second pipe portion disposed outside the tank main body and extending in a shape bent from an upper end of the first pipe portion.

In addition, the coolant injection part may be provided at the upper end of the other side of the tank main body.

In addition, the interior of the tank main body may be filled with the coolant so that a height of a surface of the coolant is higher than a height of the upper end of one side of the tank main body.

In addition, the outlet pipe may be disposed adjacent to a lower end of the other side of the tank main body.

In addition, the reservoir tank may further include: a partition wall provided in the tank main body, coupled to the tank main body, and configured to divide an internal space of the tank main body.

In addition, a communication hole may be formed in the partition wall and penetrate two opposite surfaces of the partition wall in a thickness direction of the partition wall.

### Advantageous Effects

The reservoir tank of the present invention has the inlet port, through which the coolant is introduced, and the discharge port, through which the coolant is discharged, and the reservoir tank may prevent the occurrence of bubbles in the coolant by suppressing the wave effect generated on the surface of the coolant in the reservoir tank by the flow of the coolant introduced into the reservoir tank.

### DESCRIPTION OF DRAWINGS

FIGS. 1 and 2 are front cross-sectional views illustrating a reservoir tank in the related art.

FIGS. 3 and 4 are perspective views illustrating a reservoir tank according to an embodiment of the present invention.

FIGS. 5 and 6 are front cross-sectional views illustrating the reservoir tank according to the embodiment of the present invention and a flow of a coolant.

FIG. 7 is a front cross-sectional view illustrating a reservoir tank according to another embodiment of the present invention.

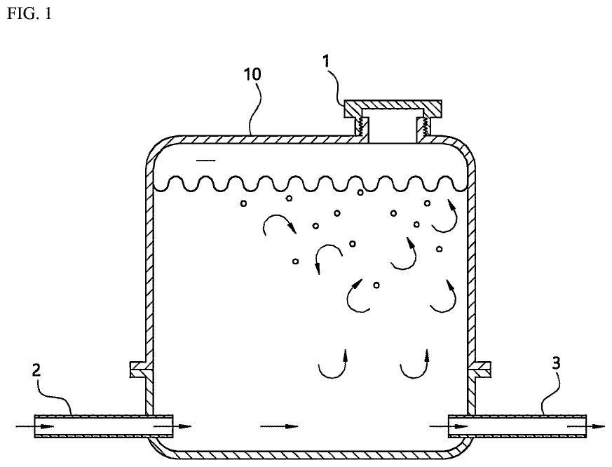

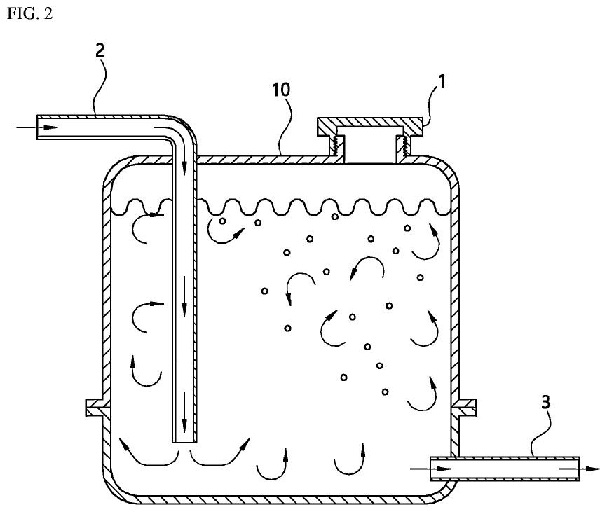

### BEST MODE

Hereinafter, a reservoir tank of the present invention configured as described above will be described in detail with reference to the accompanying drawings.

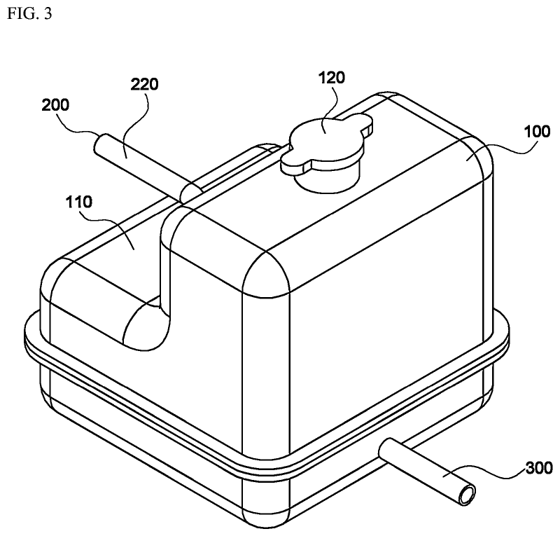

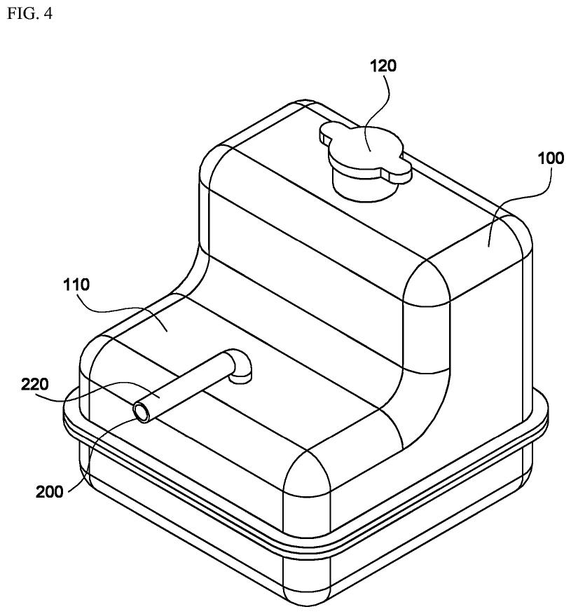

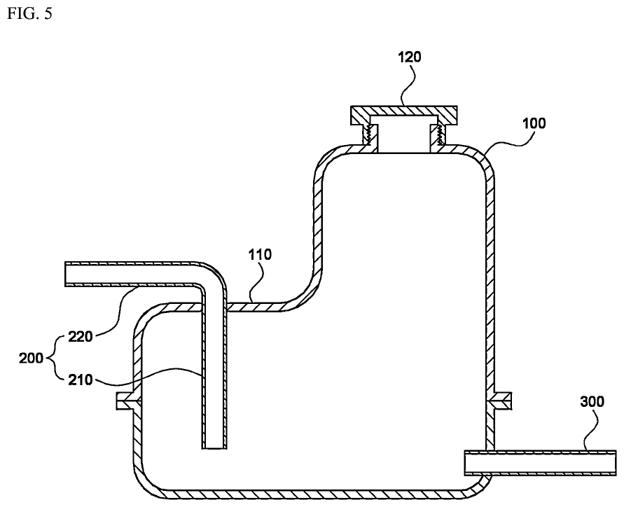

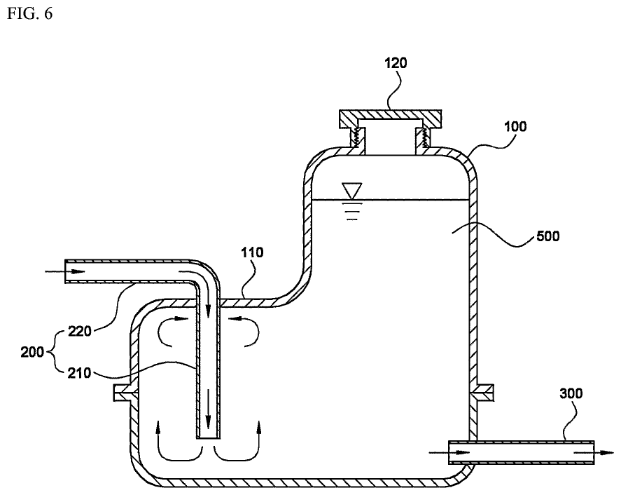

FIGS. 3 and 4 are perspective views illustrating a reservoir tank according to an embodiment of the present invention, and FIGS. 5 and 6 are front cross-sectional views illustrating the reservoir tank according to the embodiment of the present invention and a flow of a coolant.

As illustrated, the reservoir tank of the present invention may broadly include a tank main body 100, an inlet pipe 200, and an outlet pipe 300.

The tank main body 100 may be provided in the form of a container capable of storing a coolant. The tank main body 100 may be connected to a coolant line, which constitutes a coolant system, and serve to supply the coolant, which is stored in the tank main body 100, to the coolant line. Further, the tank main body 100 may be formed in a stepped shape in which a height of an upper end of one side is lower than a height of an upper end of the other side. That is, one side of the tank main body 100 may have a stepped portion 110 having an upper end with a relatively small height, and the other side of the tank main body 100 may have an upper end with a relatively large height. In addition, a coolant injection part 120 may be formed at the upper end of the other side of the tank main body 100, such that the coolant may be injected into the tank main body 100 through the coolant injection part 120.

The inlet pipe 200 may be connected to an upper surface of the stepped portion 110 that is one side of the tank main body 100, such that the inlet pipe 200 and the tank main body 100 may communicate with each other. The inlet pipe 200 extends toward a lower end of one side from an upper surface of the stepped portion 110 that is an upper end of one side of the tank main body 100, such that the coolant may be introduced into the tank main body 100 in a downward direction from above. For example, the inlet pipe 200 may include a first pipe portion 210 and a second pipe portion 220 and extend in a shape in which the second pipe portion 220 is bent from the upper end of the first pipe portion 210 in a direction in which the second pipe portion 220 intersects the first pipe portion 210. Further, the first pipe portion 210 may extend in an upward/downward direction (vertical direction) in a shape in which a part of the first pipe portion 210 is inserted into the tank main body 100. A lower end of the first pipe portion 210 may be disposed to be adjacent to and spaced apart from a bottom of one side of the tank main body 100. In addition, the second pipe portion 220 may be formed in a horizontal direction.

The outlet pipe 300 may be disposed adjacent to a lower end of the other side of the tank main body 100, and the outlet pipe 300 may communicate with the tank main body 100. The outlet pipe 300 may extend in the horizontal direction.

Further, the inlet pipe 200 and the outlet pipe 300 may be provided separately from the tank main body 100 and coupled to the tank main body 100. The inlet pipe 200 and the outlet pipe 300 may be integrated with the tank main body 100 by injection molding or the like. In addition, the inlet pipe 200 may be connected to the coolant line, such that the coolant circulating through the coolant system may be introduced into the tank main body 100 through the inlet pipe 200. In addition, the outlet pipe 300 may be connected to the coolant line, such that the coolant in the tank main body 100 may be supplied to the coolant line through the outlet pipe 300.

That is, the reservoir tank of the present invention may be coupled to the coolant system and configured such that the coolant continuously flows along the inside of the reservoir tank. In this case, as illustrated in FIG. 6, a coolant level of a coolant 500 introduced into the tank main body 100 may be higher than the upper end of one side of the tank main body 100 and lower than the upper end of the other side of the tank main body 100. Therefore, the interior of one side of the tank main body 100 may be filled with the coolant from the lower end up to the upper end. A part of an upper side of the interior of the other side of the tank main body 100 may be insufficiently filled with the coolant and filled with air.

Therefore, the reservoir tank of the present invention has the inlet port, through which the coolant is introduced, and the discharge port, through which the coolant is discharged, and the reservoir tank may be placed in a state in which the upper end of the reservoir tank at the side of the coolant inlet port, through which a large amount of coolant flows, is always filled with the coolant without air, which may prevent a wave effect. That is, it is possible to prevent the occurrence of bubbles in the coolant by suppressing the wave effect generated on the surface of the coolant in the reservoir tank by the flow of the coolant introduced into the reservoir tank.

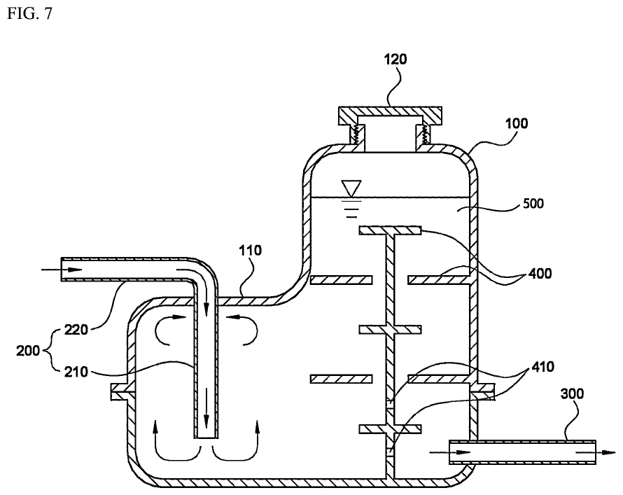

FIG. 7 is a front cross-sectional view illustrating a reservoir tank according to another embodiment of the present invention.

As illustrated, the reservoir tank of the present invention may further include partition walls 400, and the partition wall 400 may have a communication hole 410 so that the coolant may pass through the communication hole 410.

The partition wall 400 may be formed in various shapes capable of dividing the internal space of the tank main body 100 and preventing the coolant from sloshing. The partition wall 400 may be completely separated from an internal space of the tank main body 100 and divide the internal space of the tank main body 100 into spaces that communicate with one another without being sealed so that the coolant may flow through the spaces. For example, the partition wall 400 may have a shape made by combining a partition wall formed in the vertical direction and the partition wall formed in the horizontal direction. The partition wall 400 may be coupled to the tank main body 100. Alternatively, the partition wall 400 may be integrated with the tank main body 100 by injection molding. Further, the communication hole 410 may be formed in the partition wall 400 while penetrating two opposite surfaces of the partition wall 400 based on a thickness direction of the partition wall 400. The communication hole 410 may have various positions, numbers, and shapes.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Tank main body, 110: Stepped portion, 120: Coolant injection part
200: Inlet pipe, 210: First pipe portion, 220: Second pipe portion
300: Outlet pipe, 400: Partition wall, 410: Communication hole
500: Coolant

1. A reservoir tank comprising:
a tank main body having a coolant injection part and configured to store a coolant therein;
an inlet pipe connected to one side of the tank main body and configured to communicate with the inside of the tank main body; and
an outlet pipe connected to the other side of the tank main body and configured to communicate with the inside of the tank main body,
wherein a height of an upper end of one side of the tank main body is lower than a height of an upper end of the other side of the tank main body, and the inlet pipe is connected to the tank main body so that the coolant flows in a direction toward a lower end from the upper end of one side of the tank main body.

2. The reservoir tank of claim 1, wherein the reservoir tank has a stepped portion formed at one side thereof so that a height of an upper end of one side is lower than a height of an upper end of the other side.

3. The reservoir tank of claim 2, wherein the inlet pipe is connected to an upper surface of the stepped portion.

4. The reservoir tank of claim 1, wherein at least a part of the inlet pipe is inserted into one side of the tank main body, and
wherein a lower end of the inlet pipe disposed in one side of the tank main body is disposed to be adjacent to and spaced apart from the lower end of one side of the tank main body.

5. The reservoir tank of claim 1, wherein the inlet pipe comprises:
a first pipe portion extending in an upward/downward direction and partially inserted into one side of the tank main body; and
a second pipe portion disposed outside the tank main body and extending in a shape bent from an upper end of the first pipe portion.

6. The reservoir tank of claim 1, wherein the coolant injection part is provided at the upper end of the other side of the tank main body.

7. The reservoir tank of claim 1, wherein the interior of the tank main body is filled with the coolant so that a height of a surface of the coolant is higher than a height of the upper end of one side of the tank main body.

8. The reservoir tank of claim 1, wherein the outlet pipe is disposed adjacent to a lower end of the other side of the tank main body.

9. The reservoir tank of claim 1, further comprising:
a partition wall provided in the tank main body, coupled to the tank main body, and configured to divide an internal space of the tank main body.

10. The reservoir tank of claim 9, wherein a communication hole is formed in the partition wall and penetrates two opposite surfaces of the partition wall in a thickness direction of the partition wall.
